(19) United States
(12) Patent Application Publication
(10) Pub. No.: US 2014/0330928 A1
(43) Pub. Date: Nov. 6, 2014

(54) DATA SHARING SYSTEM, DATA SHARING METHOD, AND INFORMATION PROCESSING APPARATUS

(71) Applicant: Ken TAKEHARA, Tokyo (JP)

(72) Inventor: Ken TAKEHARA, Tokyo (JP)

(73) Assignee: RICOH COMPANY, LIMITED, Tokyo (JP)

(21) Appl. No.: 14/261,664

(22) Filed: Apr. 25, 2014

(30) Foreign Application Priority Data
May 2, 2013 (JP) 2013-097051

(51) Int. Cl. H04L 29/08

(52) U.S. Cl. CPC H04L 67/10
USPC 709/217

(57) ABSTRACT

A server includes a first storage unit and a second storage unit. The first storage unit stores therein user identifying information identifying a user. The second storage unit stores therein image data in a manner associated with user identifying information. A mobile terminal device includes a registering unit, an identification-information acquiring unit, a first image transmitting unit, and a second image transmitting unit. The registering unit registers a projector device. The identification-information acquiring unit acquires user identifying information corresponding to a second user different from a first user who operates the mobile terminal device from the server. The first image transmitting unit transmits first image data to the server device. The second image transmitting unit acquires second image data associated with the user identifying information acquired by the identification-information acquiring unit from the server, and transmits the acquired second image data to the projector device registered in the registering unit.

### CROSS-REFERENCE TO RELATED APPLICATIONS

The present application claims priority to and incorporates by reference the entire contents of Japanese Patent Application No. 2013-097051 filed in Japan on May 2, 2013.

### BACKGROUND OF THE INVENTION

1. Field of the Invention

The present invention relates to a data sharing system, a data sharing method, and an information processing apparatus for performing information processing via a network.

2. Description of the Related Art

Projector devices, which project an image of image data output from an information processing apparatus such as a computer on a projected medium such as a screen to display the image on the projected medium, are in widespread use. Such projector devices are suitable for use in a meeting, etc. in which information is shared by a large number of persons. Furthermore, with the development in network technology, projector devices capable of projecting an image of image data transmitted via a network are also in widespread use recently For example, image data is transmitted from a mobile terminal device having a communication function of performing communication via a network, such as a smartphone or a tablet computer, to a projector device via the network, so that the projector device can project an image of the image data.

For example, in a remote meeting, if devices such as personal computers (PCs), smartphones, tablet computers, electronic blackboard devices, and projector devices installed in multiple remote locations can share respective projected images with others, it is possible to hold a meeting in the multiple locations by using common information in real time, and this is efficient.

Japanese Patent Application Laid-open No. 2012-108872 (hereinafter, referred to as “patent document 1”) has disclosed a technology that allows to share an input operation screen among multiple devices such as smartphones, tablet computers, and projector devices connected to one another via a network. Specifically, in the technology disclosed in the patent document 1, operation authority for an input operation is transferred among multiple devices connected to one another via a network, and a device having the operation authority transmits transmission data including operation information on an input operation performed on the device to the other devices. When having received the transmission data, the other devices display a display object in accordance with the operation information included in the transmission data.

However, conventionally, there is a problem that sharing of respective projected images among, for example, multiple devices installed in remote locations is not efficiently performed.

For example, assume that projector devices A and B, which can communicate with each other via a network, are installed in meeting rooms A and B remote from each other, respectively. In this state, think about the case where, for example, a user A in the meeting room A transmits image data of an image taken with his/her mobile terminal device A to the projector device A via the network to cause the projector device A to project the image of the image data, and also the projector device B is caused to project the image of the image data as well.

In this case, it is necessary to establish communication between the mobile terminal device A and the projector device B and then to cause the mobile terminal device A to transmit the image to the projector device B. In conventional technologies, to establish communication with the projector device B, for example, the mobile terminal device A searches for any projector devices connected to the network. The mobile terminal device A displays a list of projector devices retrieved as a result of the search on a display. The user finds and selects the specific projector device B from the list of projector devices displayed on the display.

However, the projector device B in the meeting room B is in a remote location from the mobile terminal device A in the meeting room A; therefore, if the projector device B is not present in a search area of the mobile terminal device A, the user may not be able to select the projector device B through the mobile terminal device A.

Furthermore, at this time, the list of projector devices is displayed in the form of information that can certainly identify the projector devices, such as MAC (Media Access Control) addresses or IP (Internet Protocol) addresses. This identification information is a numerical string in hex or decimal notation; therefore, there is a problem that it is difficult for the user to specify the target projector device B, thus it is difficult to share the image between the devices A and B. This problem is not solved by the above-described technology disclosed in the patent document 1.

In view of the above, there is a need to facilitate sharing of an image among remote locations.

### SUMMARY OF THE INVENTION

It is an object of the present invention to at least partially solve the problems in the conventional technology.

According to the present invention, there is provided a data sharing system in which an information processing system composed of one or more computer devices and multiple information processing apparatuses are connected via a network so that the information processing system and the information processing apparatuses can communicate with one another, wherein each information processing apparatus includes: a device-specific-information acquiring unit configured to acquire device-specific information; a connecting unit configured to connect the information processing apparatus to a display device specified on the basis of the acquired device-specific information; a sharing-target transmitting unit configured to transmit designation information designating a sharing target of data sharing to the information processing system; a first data transmitting unit configured to transmit, to the information processing system, shared data to be shared with the sharing target designated by the designation information; a data receiving unit configured to receive, out of the shared data that the information processing system has received and recorded in a storage unit, shared data to be shared with the information processing apparatus designated as a sharing target from the information processing system; and a second data transmitting unit configured to transmit the shared data received by the data receiving unit to the display device connected by the connecting unit, and the information processing system includes: a sharing-target receiving unit configured to receive the designation information from the information processing apparatus; and a data recording unit configured to records, in the storage unit, the shared data received from information processing apparatus in a manner associated with the sharing target indicated by the designation information received by the sharing-target receiving unit.

The present invention also provides an information processing apparatus in a data sharing system in which an information processing system composed of one or more computer devices and multiple information processing apparatuses are connected via a network so that the information processing system and the information processing apparatuses can communicate with one another, the information processing apparatus comprising: a device-specific-information acquiring unit configured to acquire device-specific information; a connecting unit configured to connect the information processing apparatus to a display device specified on the basis of the acquired device-specific information; a sharing-target transmitting unit configured to transmit, to the information processing system, designation information to designate a sharing target of data sharing; a first data transmitting unit configured to transmit, to the information processing system, shared data to be shared with the sharing target designated by the designation information; a data receiving unit configured to receive, out of shared data that the information processing system has received and recorded in a storage unit, shared data to be shared with the information processing apparatus designated as a sharing target from the information processing system; and a second data transmitting unit configured to transmit the shared data received by the data receiving unit to the display device connected by the connecting unit.

The present invention also provides a data sharing method for sharing data between first and second information processing apparatuses which are connected to an information processing system composed of one or more computer devices via a network so that the information processing system and the first and second information processing apparatuses can communicate with one another, the data sharing method comprising: a device-specific-information acquiring step of the first information processing apparatus acquiring device-specific information; a connecting step of the first information processing apparatus connecting to a display device specified on the basis of the acquired device-specific information; a displaying step of the second information processing apparatus displaying a screen through which a sharing target of data sharing is designated; a sharing-target transmitting step of the second information processing apparatus transmitting, to the information processing system, designation information to designate the sharing target; a first data transmitting step of the second information processing apparatus transmitting, to the information processing system, shared data to be shared with the designated sharing target; a data receiving step of the first information processing apparatus transmitting sharing-target identifying information that identifies the sharing target to the information processing system and receiving, out of the shared data transmitted at the first data transmitting step, shared data to be shared with the first information processing apparatus designated as a sharing target from the information processing system on the basis of the sharing-target identifying information; and a second data transmitting step of the first information processing apparatus transmitting the data received at the data receiving step to the display device connected at the connecting step.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram schematically showing a configuration of an information processing system according to an embodiment;

FIG. 2 is a diagram showing an example of a user ID table according to the embodiment;

FIG. 3 is a diagram showing an example of a configuration of a message-box storage unit according to the embodiment;

FIG. 4 is a block diagram schematically showing an example of a hardware configuration of a server device according to the embodiment;

FIG. 5 is a block diagram showing an example of a hardware configuration of a mobile terminal device according to the embodiment;

FIG. 6 is an illustrative functional block diagram for explaining functions of the mobile terminal device according to the embodiment;

FIG. 7 is an illustrative functional block diagram for explaining functions of a projector device according to the embodiment;

FIG. 8 is a sequence diagram showing an example of operation of the information processing system according to the embodiment;

FIG. 9 is a diagram showing an example of a main screen of an information processing program according to the embodiment;

FIG. 10 is a diagram showing an example of a scan screen according to the embodiment; and

FIGS. 11(a) to 11(c) are diagrams showing examples of an imaging screen according to the embodiment.

### DETAILED DESCRIPTION OF THE PREFERRED EMBODIMENTS

An exemplary embodiment of a data sharing system, data sharing method, and information processing apparatus according to the present invention will be explained in detail below with reference to accompanying drawings.

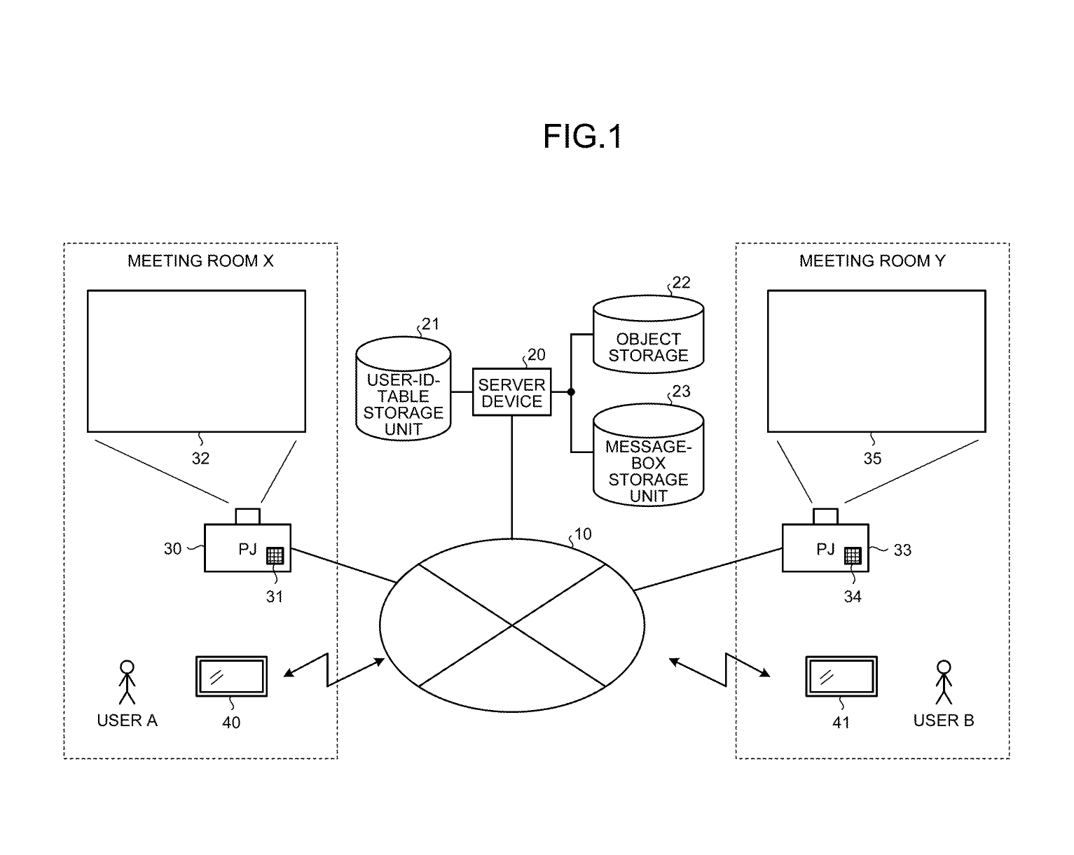

FIG. 1 schematically shows a configuration of an information processing system as an example of the data sharing system according to the embodiment. This information processing system enables a projector device installed in a place where a user B who uses the projector device is to easily project an image owned by a user A who is in a different place from the user B.

In FIG. 1, a network 10 is, for example, the Internet, a local area network (LAN), or a wide area network (WAN). As a communication protocol, for example, TCP/IP (Transmission Control Protocol/Internet Protocol) can be applied to the network 10. A server device 20, multiple projector devices (denoted by PJ in the drawings) 30 and 33, and mobile terminal devices 40 and 41 are connected to the network 10.

The projector devices 30 and 33 project an image of image data input from a given input interface (I/F) on screens 32 and 35 which are projected media, respectively. Furthermore, the projector devices 30 and 33 can project an image of image data transmitted via the network 10 on the screens 32 and 35, respectively.

Information that can specify each device on the network 10 is displayed on respective housings of the projector devices 30 and 33. As the information that can specify each device on the network 10 (hereinafter, referred to as “device-specific information”), a MAC (Media Access Control) address unique to a communication I/F of the device can be used. However, the device-specific information is not limited to this, and IP (Internet Protocol) addresses assigned to the projector devices 30 and 33 can be used, or device names uniquely given to the projector devices 30 and 33 can be used.

The device-specific information is encoded into a two-dimensional matrix code such as a QR code (registered trademark), and the encoded two-dimensional matrix code is printed on a printed medium, and then the printed medium is stuck, for example, to the housing of the projector device 30. The way of displaying the device-specific information on the projector devices 30 and 33 is not limited to the way of using a two-dimensional matrix code. For example, the device-specific information can be encoded into a one-dimensional bar code and the one-dimensional bar code is printed, or a character string of the device-specific information can be directly printed.

The mobile terminal devices 40 and 41 are connected to the network 10 by wireless communication. The mobile terminal devices 40 and 41 each have an imaging function, and can take an image of a subject by using the imaging function and obtain image data of the image. Furthermore, the mobile terminal devices 40 and 41 can transmit data owned by them via the network 10. For example, the mobile terminal devices 40 and 41 can transmit obtained image data of an image taken by the imaging function via the network 10. Moreover, the mobile terminal devices 40 and 41 each have a function of detecting a two-dimensional matrix code included in image data and decoding the detected two-dimensional matrix code. Furthermore, the mobile terminal devices 40 and 41 each have a function of sending an e-mail via the network 10 and an address book function of registering an e-mail address in an address book.

Here, the projector device 30 shall be installed in a first area (a meeting room X), and the projector device 33 shall be installed in a second area (a meeting room Y) which is a different place from the first area. Furthermore, the mobile terminal device 40 shall be operated by the user A in the first area, and the mobile terminal device 41 shall be operated by the user B in the second area.

Incidentally, here, there is described an example of an installation environment where the projector devices 30 and 33 are installed in different places (the meeting rooms X and Y), respectively; however, the installation environment of the projector devices 30 and 33 is not limited to this example. For example, the projector devices 30 and 33 can be installed in different places within one big venue. That is, here, there is described an environment where the projector devices 30 and 33 are installed in different places as an example of a state in which the projector device 30 and the mobile terminal device 40 share data and data manipulation through linkage function via a network, and the projector device 33 and the mobile terminal device 41 share data and data manipulation through linkage function via a network.

The server device 20 can be composed of one information processing apparatus such as one computer, or can be dispersively composed of multiple computers. A user-ID-table storage unit 21, an object storage 22, and a message-box storage unit 23 are connected to the server device 20. The user-ID-table storage unit 21, the object storage 22, and the message-box storage unit 23 can be externally connected to the server device 20, or can be included in the server device 20.

The user-ID-table storage unit 21 stores therein a user ID table in which user IDs, i.e., respective pieces of identification information of the users A and B are associated with information that indicate the users A and B transmitted from the mobile terminal devices 40 and 41. For instance, the server device 20 uses an e-mail address owned by a user as user information that indicates the user to create a user ID for, for example, an e-mail address of the user A transmitted from the mobile terminal device 40. The server device 20 stores the user ID together with the e-mail address of the user A in an associated manner in the user ID table stored in the user-ID-table storage unit 21.

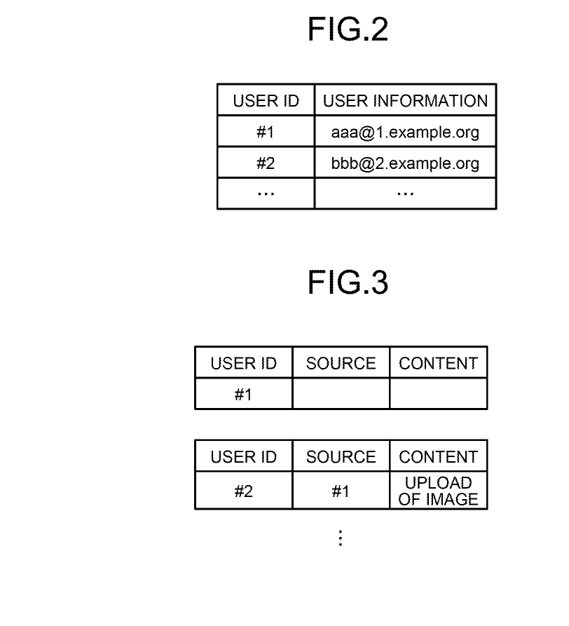

FIG. 2 shows an example of the user ID table stored in the user-ID-table storage unit 21 according to the embodiment. An e-mail address as user information of the user A is “aaa@1.example.org”, and an e-mail address as user information of the user B is “bbb@2.example.org”. The server device 20 creates, for example, user ID “#1” for the e-mail address “aaa@1.example.org” of the user A transmitted from the mobile terminal device 40, and stores the user ID “#1” together with the e-mail address “aaa@1.example.org” in an associated manner in the user-ID-table storage unit 21. Likewise, the server device 20 creates user ID “#2” for the e-mail address “bbb@2.example.org” of the user B, and stores, in the user-ID-table storage unit 21, the user ID “#2” together with the e-mail address “bbb@2.example.org” in an associated manner in the user ID table.

A password to be described later can be further stored in the user ID table in a manner associated with the user ID and the e-mail address.

Incidentally, each of the mobile terminal devices 40 and 41 can transmit not only an e-mail address of a user who operates itself but also e-mail addresses of other users to the server device 20. For example, the user A can transmit the e-mail address of the user B who is related to the projector device 33, which is a target device expected to project an image owned by the user A, to the server device 20 together with the e-mail address of the user A through the use of the mobile terminal device 40. Also in this case, the server device 20 creates user IDs for the e-mail addresses of the users A and B transmitted from the mobile terminal device 40, and stores, in the user-ID-table storage unit 21, the created user IDs in a manner associated with the e-mail addresses of the users A and B, respectively in the user ID table.

At this time, as user-indicating information, it is preferable to use a character string representing an e-mail address; one-byte alphanumeric characters of the character string are separated by “@ (at mark)”, and the latter one-byte alphanumeric characters subsequent to the at mark “@” are further separated by “. (periods)”. By using such a character string representing an e-mail address, an e-mail address book that the mobile terminal devices 40 and 41 each generally have can be used.

Furthermore, the server device 20 can use an e-mail address of each user as a user ID that identifies the user.

Incidentally, the user-indicating information transmitted from the mobile terminal devices 40 and 41 to the server device 20 is not limited to an e-mail address. In other words, the user-indicating information can be any information as long as the server device 20 can identify each user on the information processing system by the information; for example, an arbitrary character string, such as a user account, and a user's face image, etc. can be used as the user-indicating information. That is, an e-mail address is just one means selected because cell-phone terminals, personal handy-phone system (PHS) terminals, smartphones, and tablet computers, etc., which can be applied as the mobile terminal devices 40 and 41, are normally provided with an address book function capable of registering e-mail addresses of an owner and other users.

The message-box storage unit 23 stores therein a message box in which messages sent from the mobile terminal devices 40 and 41 are stored in a manner associated with a user ID corresponding to a destination mobile terminal device. Furthermore, in the message-box storage unit 23, the message box stores therein at least a user ID corresponding to a source mobile terminal device of a message.

FIG. 3 shows an example of a configuration of the message-box storage unit 23 according to the embodiment. The server device 20 creates a message box with respect to each user ID, and stores the created message box in the message-box storage unit 23. In the example shown in FIG. 3, a message box for user ID “#1” corresponding to the user A who operates the mobile terminal device 40 (hereinafter, arbitrarily referred to as the message box #1) and a message box for user ID “#2” corresponding to the user B who operates the mobile terminal device 41 (hereinafter, arbitrarily referred to as the message box #2) are created. These message boxes #1 and #2 are stored in the message-box storage unit 23.

Each message box stores therein at least a user ID of a user who operates a source mobile terminal device that has sent a message. For example, as shown in FIG. 3, when the user A has sent a message to the user B through the mobile terminal device 40, “#1”, which is a user ID of a source of the message, is stored as a “source” in the message box #2 for user ID “#2” corresponding to the user B.

Other information can be further stored in each message box in a manner associated with a user ID. In the example shown in FIG. 3, in the message box #2 for user ID “#2”, information indicating that an image was uploaded has been stored as “content”.

The object storage 22 stores therein image data transmitted from the mobile terminal devices 40 and 41. Image data is stored in the object storage 22 in a manner associated with a user ID of a user who operates a source mobile terminal device. For example, image data transmitted from the mobile terminal device 40 operated by the user A is stored in the object storage 22 in a manner associated with user ID “#1” corresponding to the user A.

Incidentally, when image data associated with the same user ID as already-stored image data is stored in the object storage 22, the already-stored image data with the same user ID is overwritten with the new image data. For example, assume that image data associated with user ID “#1” has already been stored in the object storage 22. In this state, when new image data has been transmitted from the mobile terminal device 40 by the user A with user ID “#1”, the already-stored image data is overwritten with the new image data. In other words, with respect to each user ID, the latest image datum is associated with the user ID and stored in the object storage 22.

However, the configuration of the object storage 22 is not limited to this; alternatively, the object storage 22 can be configured to store therein multiple image data transmitted from one user. Even in this case, the object storage 22 can know the latest image datum from timestamps of the image data.

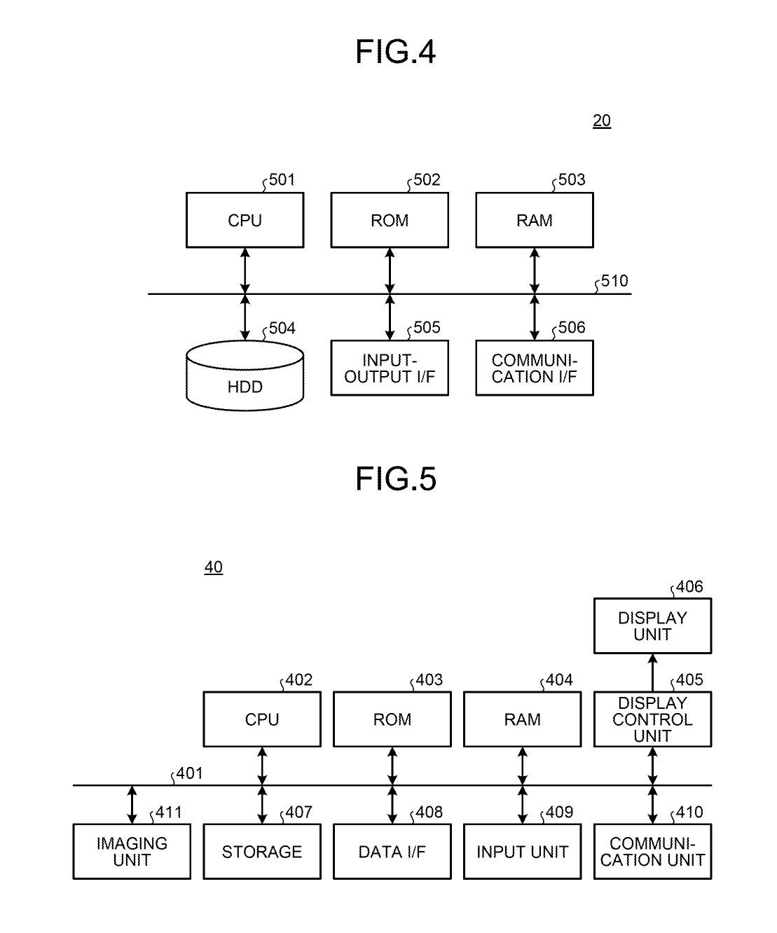

FIG. 4 schematically shows an example of a hardware configuration of the server device 20 according to the embodiment. A configuration of a general computer device can be applied to the server device 20; the server device 20 includes a central processing unit (CPU) 501, a read-only memory (ROM) 502, a random access memory (RAM) 503, a hard disk drive (HDD) 504, an input-output interface (I/F) 505, and a communication I/F 506. The CPU 501, the ROM 502, the RAM 503, the HDD 504, the input-output I/F 505, and the communication I/F 506 are connected by a bus 510 so that they can communicate with one another.

The CPU 501 works using the RAM 503 as a working memory in accordance with a program which has been stored in the ROM 502 or the HDD 504 in advance, and controls the operation of the entire server device 20. The HDD 504 has stored therein a program causing the CPU 501 to work. Furthermore, the HDD 504 includes the user-ID-table storage unit 21 (a first storage unit), the object storage 22 (a second storage unit), and the message-box storage unit 23 (a third storage unit).

Incidentally, in the example shown in FIG. 4, the server device 20 includes one HDD 504; however, the configuration of the server device 20 is not limited to this example, and the server device 20 can include a plurality of HDDs 504. For example, the user-ID-table storage unit 21, the object storage 22, and the message-box storage unit 23 can be included in different HDDs 504, respectively. Furthermore, the user-ID-table storage unit 21, the object storage 22, and the message-box storage unit 23 can be set up inside of the server device 20, or can be set up outside of the server device 20 and connected to the server device 20 via the network 10.

The input-output I/F 505 is an interface for input/output of data to the server device 20. For example, an input device such as a keyboard for receiving user input can be connected to the input-output I/F 505. Furthermore, a data interface for performing data input/output with another device such as a universal serial bus (USB) and a drive device that reads data from a recording medium such as a compact disk (CD) or a digital versatile disk (DVD) can be connected to the input-output I/F 505. Moreover, a display device that displays thereon a display control signal generated by the CPU 501 as an image can be connected to the input-output I/F 505.

The communication I/F 506 performs communication via the network 10 in accordance with control by the CPU 501. The communication I/F 506 can communicate with the mobile terminal devices 40 and 41 via a wireless access point connected to the network 10.

Subsequently, the mobile terminal devices 40 and 41 are explained. Incidentally, the mobile terminal devices 40 and 41 can be implemented by the same configuration, so the mobile terminal device 40 is representatively explained below.

FIG. 5 shows an example of a hardware configuration of the mobile terminal device 40 according to the embodiment. In the mobile terminal device 40 illustrated in FIG. 5, a CPU 402, a ROM 403, a RAM 404, and a display control unit 405 are connected to a bus 401. Furthermore, a storage 407, a data i/F 408, an input unit 409, a communication unit 410, and an imaging unit 411 are connected to the bus 401. The storage 407 is a storage medium capable of storing therein data in a non-volatile manner, and is, for example, a non-volatile semiconductor memory such as a flash memory. However, the storage 407 is not limited to this; alternatively, an HDD can be used as the storage 407.

The CPU 402 controls the entire mobile terminal device 40 by using the RAM 404 as a working memory in accordance with programs stored in the ROM 403 and the storage 407. The display control unit 405 converts a display control signal generated by the CPU 402 into a signal that a display unit 406 can display thereon, and outputs the converted signal.

The storage 407 stores therein a program executed by the CPU 402 and various data. Incidentally, for example, one rewritable non-volatile semiconductor memory can be used as both the storage 407 and the ROM 403. The data I/F 408 performs data input/output with an external device. As the data i/F 408, for example, a USB interface or a Bluetooth (registered trademark) interface, etc. can be used.

The display control unit 405 drives the display unit 406 on the basis of a display control signal generated by the CPU 402. The display unit 406 includes, for example, a liquid crystal display (LCD), and is driven by the display control unit 405 to display thereon information based on the display control signal.

The input unit 409 includes an input device for receiving user input. A user can issue an instruction to the mobile terminal device 40 by operating the input device, for example, in response to information displayed on the display unit 406. Incidentally, it is preferable that the input device for receiving user input is integrated with the display unit 406 so as to be constituted as a touch panel that outputs a control signal corresponding to the touch position and transmits an image on the display unit 406.

The communication unit 410 includes a communication I/F that performs wireless communication via the network 10 in accordance with control by the CPU 402.

The imaging unit 411 includes an optical system, an imaging element, and a drive control circuit for controlling the optical system and the imaging element, and performs predetermined processing on an imaging signal output from the imaging element and outputs the processed imaging signal as image data. The imaging unit 411 executes a function, such as imaging or zoom, in accordance with an instruction made through a user operation on the input unit 409. The image data output from the imaging unit 411 is transmitted to the CPU 402 via the bus 401, and the CPU 402 performs predetermined image processing on the image data in accordance with a program. The image data which has been output from the imaging unit 411 and subjected to the image processing can be stored, for example, in the storage 407. The operation of storing image data output from the imaging unit 411 in the storage 407 in this way is referred to as imaging. Furthermore, the CPU 402 can read image data from the storage 407 and cause the communication unit 410 to transmit the read image data to the server device 20 via the network 10.

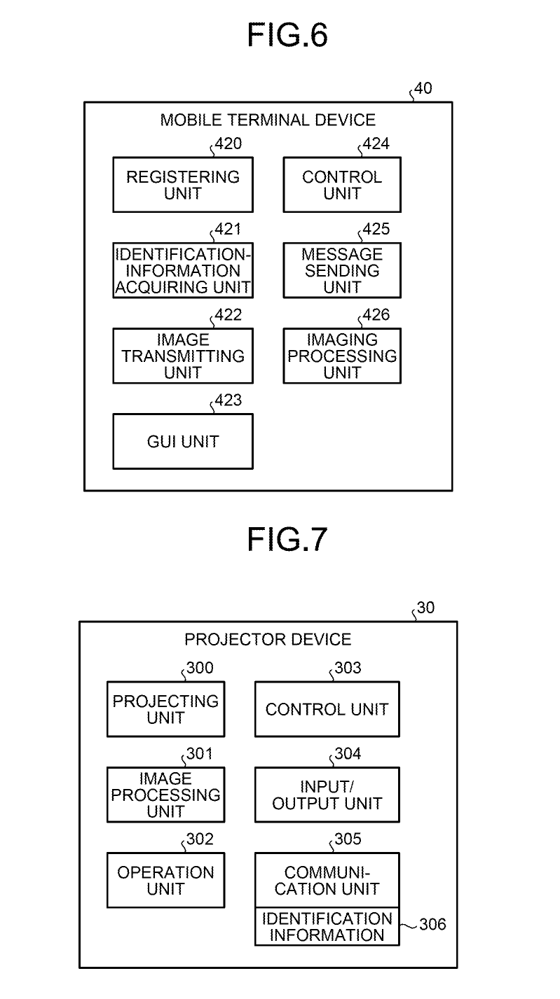

FIG. 6 is an illustrative functional block diagram for explaining functions of the mobile terminal device 40 according to the embodiment. The mobile terminal device 40 includes a registering unit 420, an identification-information acquiring unit 421, an image transmitting unit 422, a graphical user interface (GUI) unit 423, a control unit 424, a message sending unit 425, and an imaging processing unit 426. The control unit 424 controls the entire mobile terminal device 40, for example, by the CPU 402 working in accordance with a program.

The imaging processing unit 426 performs predetermined image processing on image data output from the imaging unit 411 and outputs the processed image data. Furthermore, the imaging processing unit 426 can extract a two-dimensional matrix code included in the image data output from the imaging unit 411 and decode the two-dimensional matrix code. The registering unit 420 registers the projector device 30 by storing device-specific information 31 of the projector device 30 in the RAM 404 or the like. For example, the registering unit 420 extracts a two-dimensional matrix code from image data output from the imaging unit 411 and decodes the extracted two-dimensional matrix code, thereby acquiring the device-specific information 31 of the projector device 30.

The identification-information acquiring unit 421 transmits information that indicates the user A who operates the mobile terminal device 40 and information that indicates another user to the server device 20, and acquires respective user IDs of the users. The information that indicates the user A and the information that indicates another user are input by user operation on, for example, the GUI unit 423 to be described later.

The image transmitting unit 422 transmits image data via the network 10. For example, the image transmitting unit 422 transmits image data read from the storage 407 to the server device 20 via the network 10. At this time, the image transmitting unit 422 serves as a first image transmitting unit that transmits the image data with the addition of the user ID corresponding to the information that indicates the user A, which has been acquired by the identification-information acquiring unit 421. When the image transmitting unit 422 transmits image data to the server device 20, the image transmitting unit 422 transmits the image data together with the user ID corresponding to the information that indicates the user A in an associated manner.

Incidentally, the image transmitting unit 422 can encrypt the image data by a predetermined encryption method and transmit the encrypted image data. As an encryption key, a password to be described later can be used. Furthermore, the image transmitting unit 422 can decrypt encrypted image data received from the server device 20.

Moreover, the image transmitting unit 422 serves as a second image transmitting unit that transmits image data to the projector device 30 of which the device-specific information 31 is registered by the registering unit 420.

The GUI unit 423 forms a display image to be displayed on the display unit 406, and receives user input to the input unit 409 and constructs a GUI of the mobile terminal device 40.

The registering unit 420, the identification-information acquiring unit 421, the image transmitting unit 422, the GUI unit 423, the control unit 424, the message sending unit 425, and the imaging processing unit 426 are stored in the ROM 403 or the storage 407 in advance, and are realized by a program running on the CPU 402. The program is stored, for example, on a computer connected to the mobile terminal device 40 via the network 10 through the communication unit 410, and is provided by the user A downloading the program via the network. However, the way of providing the program is not limited to this; for example, the program can be recorded on a computer-readable recording medium, such as a CD or a DVD, in an installable or executable file format, and the recording medium can be provided.

The program is composed of, for example, modules including the above-described units (the registering unit 420, the identification-information acquiring unit 421, the image transmitting unit 422, the GUI unit 423, the control unit 424, the message sending unit 425, and the imaging processing unit 426), and, as actual hardware, the CPU 402 reads the program from a storage device such as the ROM 403 or the storage 407 and executes the read program, thereby loading the above-described units onto a main storage device (for example, the RAM 404), and the units are created on the main storage device.

Subsequently, the projector devices 30 and 33 are explained. Incidentally, the projector devices 30 and 33 can be implemented in the same configuration, so the projector device 30 is representatively explained below.

FIG. 7 is an illustrative functional block diagram for explaining functions of the projector device 30 according to the embodiment. The projector device 30 includes a projecting unit 300, an image processing unit 301, an operation unit 302, a control unit 303, an input/output unit 304, and a communication unit 305. The control unit 303 includes, for example, a CPU, a ROM, and a RAM, and controls the operation of the entire projector device 30 by using the RAM as a working memory in accordance with a program which has been stored in the ROM in advance.

The projecting unit 300 includes a light source, a light modulating unit that modulates a light from the light source according to image data, and an emission optical system that emits the light modulated by the light modulating unit to the outside. The image processing unit 301 performs predetermined image processing on image data and supplies the processed image data to the projecting unit 300. The operation unit 302 includes an input unit, which receives user operation and passes the received user operation to the control unit 303, and a display unit that displays thereon a state of the projector device 30, etc. in response to a display control signal generated by the control unit 303.

The input/output unit 304 inputs/outputs data to/from an external device. As the input/output unit 304, for example, a USB interface or a Bluetooth (registered trademark) interface, etc. can be used.

The communication unit 305 includes a communication I/F that performs communication via the network 10 in accordance with control by the control unit 303. Identification information 306 is information identifying the communication unit 305 on the network 10; for example, a MAC address uniquely assigned to the communication I/F as hardware that the communication unit 305 includes can be used as the identification information 306.

In accordance with control by the control unit 303, the projector device 30 can receive image data transmitted via the network 10 from the communication unit 305 and supplies the image data to the projecting unit 300 via the image processing unit 301. The projecting unit 300 projects the supplied image data on the screen 32. In this manner, the projector device 30 can project an image of image data transmitted via the network 10 on the screen 32.

There is explained an example where in the configuration described above, the user A in the meeting room X and the user B in the meeting room Y remote from the meeting room X have a meeting by using a shared image. In this case, for example, the mobile terminal device 40 transmits a taken image to the server device 20 in response to an operation made by the user A. Through the mobile terminal device 41, the user B receives image data of the image that the user A has transmitted from the server device 20, and transmits the received image data to the projector device 33 which has been registered in the mobile terminal device 41 in advance. The projector device 33 projects an image of the received image data on the screen 35. Accordingly, the user A can share the image with the user B and other meeting participants in the meeting room Y.

Furthermore, the mobile terminal device 40 for the user A can transmit the image data of the taken image to the projector device 30 which has been registered in the mobile terminal device 40 in advance. The projector device 30 projects an image of the image data transmitted from the mobile terminal device 40 on the screen 32. Accordingly, the image provided by the user A can be shared by all meeting participants in the meeting rooms X and Y remote from each other.

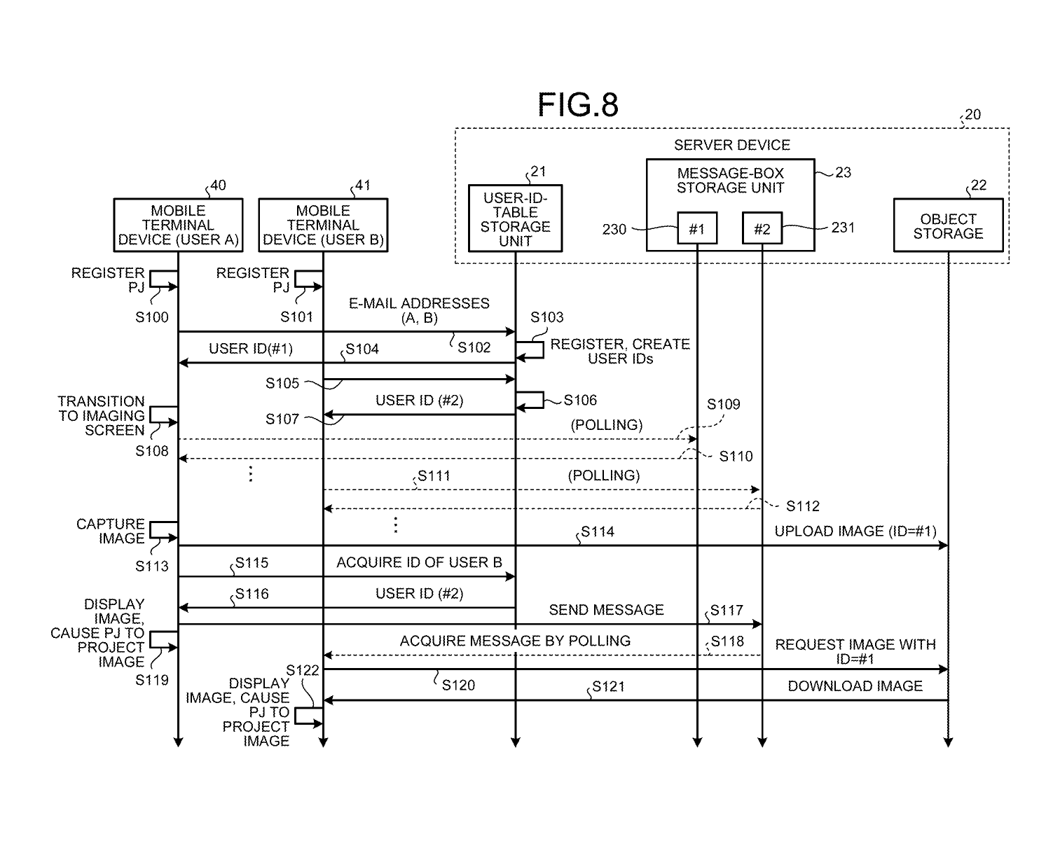

FIG. 8 is a sequence diagram showing an example of operation of the information processing system according to the embodiment. Here, there is described the case where an image taken with the mobile terminal device 40 is shared by the user A (the meeting room X) and the user B (the meeting room Y) as described above. Incidentally, in FIG. 8, a component in common with FIG. 1 is assigned the same reference numeral, and detailed description of the component is omitted.

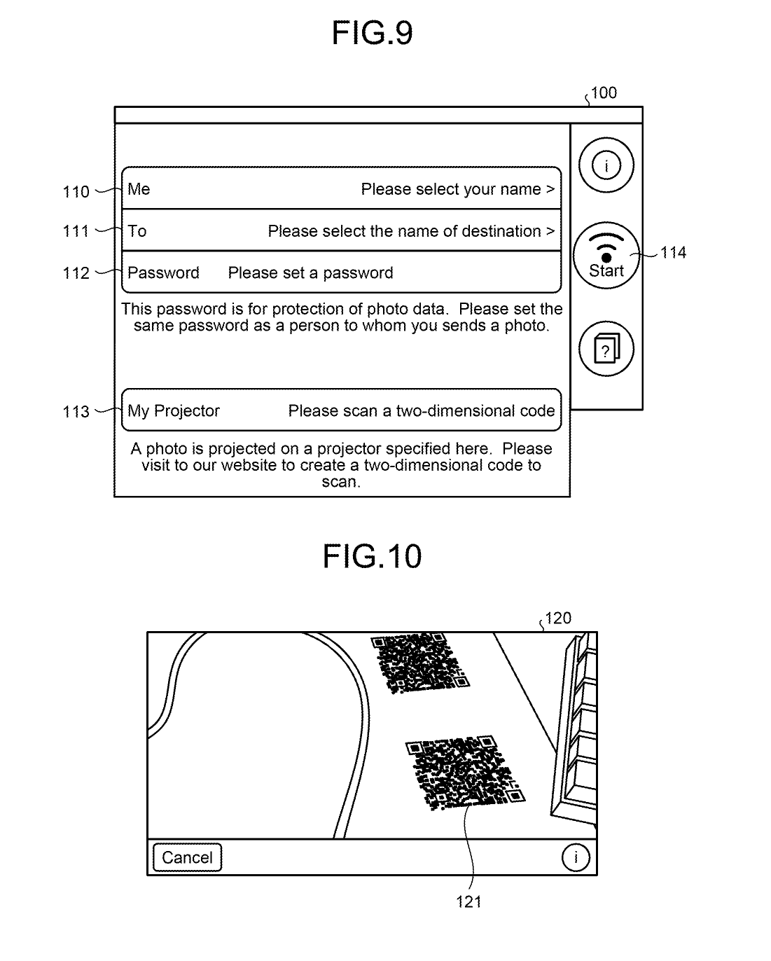

First, the user A operates the mobile terminal device 40 to start an information processing program according to the embodiment. FIG. 9 shows an example of a main screen 100 displayed on the display unit 406 of the mobile terminal device 40 at startup of the information processing program according to the embodiment. The main screen 100 is provided with input boxes 110, 111, and 112, a scan start button 113, and a submit button 114.

The input box 110 is a box to which information indicating the user A who operates the mobile terminal device 40 is input. The input box 111 is a box to which information indicating the user B with whom the user A shares an image is input. The input box 112 is a box to which a password is input. The scan start button 113 is a button for extracting a two-dimensional matrix code included in image data output from the imaging unit 411 and decoding the extracted two-dimensional matrix code. The submit button 114 is a button for transmitting information input to the input boxes 110 to 112 to the server device 20.

At Step S100, the projector device 30 is registered by the mobile terminal device 40. Specifically, the user A presses the scan start button 113 provided on the main screen 100 of the mobile terminal device 40, thereby acquiring an image of a two-dimensional matrix code stuck to the projector device 30.

FIG. 10 shows an example of a scan screen 120 according to the embodiment that is displayed on the display unit 406 when a pressing operation on the scan start button 113 has been made. On the scan screen 120, an image of image data output from the imaging unit 411 is displayed. The imaging processing unit 426 analyzes the image data displayed on the scan screen 120, and detects a two-dimensional matrix code 121 from the image data. The imaging processing unit 426 decodes the detected two-dimensional matrix code 121, and acquires the device-specific information 31 of the projector device 30. The mobile terminal device 40 stores the acquired device-specific information 31, for example, in the RAM 404, thereby registering the projector device 30.

Likewise, at Step S101, the projector device 33 is registered by the mobile terminal device 41. Specifically, the user B operates the mobile terminal device 41 to start the information processing program according to the embodiment, thereby the main screen 100 is displayed on the display unit 406 of the mobile terminal device 41. By the user B pressing the scan start button 113, an image of the projector device 33 is output by the imaging unit 411. The imaging processing unit 426 of the mobile terminal device 41 detects a two-dimensional matrix code from the image data output from the imaging unit 411 and decodes the detected two-dimensional matrix code, thereby acquiring device-specific information 34 of the projector device 33.

Incidentally, the processes in the mobile terminal device 40 and the processes in the mobile terminal device 41 are independent of each other, and are not synchronized.

Furthermore, the user A inputs information indicating the user A to the input box 110 on the main screen 100 of the mobile terminal device 40. Moreover, the user A inputs information indicating the user B to the input box 111. Here, user-indicating information shall be an e-mail address; the information indicating the user A is an e-mail address A, and the information indicating the user B is an e-mail address B.

Here, the user A can register the information indicating the user A and the information indicating the user B in the mobile terminal device 40 in advance. For example, if the information indicating the user A and the information indicating the user B are e-mail addresses or information in the form of an e-mail address, the information indicating the user A and the information indicating the user B are registered in an address book built into the mobile terminal device 40 in advance. The input boxes 110 and 111 can be configured to cause a user to select appropriate information from multiple pieces of information registered in the address book. However, the configurations of the input boxes 110 and 111 are not limited to this; alternatively, the input boxes 110 and 111 can be configured to directly receive input of the information indicating the user A and input of the information indicating the user B, respectively.

Furthermore, the user A inputs a password to the input box 112. An arbitrary character string can be used as the password. As described above, the password is used as an encryption key at the time of transmission of image data to the server device 20. Furthermore, the password can be used in combination with the e-mail address A of the user A for authentication performed when the mobile terminal device 40 has access to the server device 20.

After completion of the input to the input boxes 110 to 112, when the user A has pressed the submit button 114, the mobile terminal device 40 transmits the input e-mail addresses A, B, and the password to the server device 20 (Step S102).

When the server device 20 has received the e-mail addresses A and B from the mobile terminal device 40, the server device 20 searches a user ID table in which the received e-mail addresses A and B are associated with user IDs, respectively. When a corresponding user ID table is not retrieved from the user-ID-table storage unit 21, the server device 20 creates respective user IDs for the e-mail addresses A and B. Then, the server device 20 creates a user ID table in which the e-mail addresses A and B are associated with the created user IDs respectively, and stores/registers the created user ID table in the user-ID-table storage unit 21 (Step S103). Here, the server device 20 creates user ID “#1” for the e-mail address A, and creates user ID “#2” for the e-mail address B.

When having registered the user ID table, the server device 20 transmits the corresponding user ID “#1” to the mobile terminal device 40 (Step S104). The mobile terminal device 40 stores the user ID “#1” transmitted from the server device 20 in, for example, the RAM 404.

As for the mobile terminal device 41 for the user B, the same process is performed. That is, the user B performs inputs to the input boxes 110, 111, and 112 in accordance with the main screen 100 displayed on the display unit 406 of the mobile terminal device 41. In this case, the e-mail address B of the user B is input to the input box 110, and the e-mail address A of the user A is input to the input box 111.

When the user B has pressed the submit button 114, the mobile terminal device 41 transmits the e-mail addresses A, B, and the password input to the input boxes 110 to 112 to the server device 20 (Step S105). In this case, on the basis of the e-mail addresses A and B which have already been transmitted from the mobile terminal device 40, the user ID table has been created and registered in the user-ID-table storage unit 21. Therefore, the server device 20 retrieves the registered user ID table from the user-ID-table storage unit 21, and extracts the user ID “#2” corresponding to the mobile terminal device 41 (Step S106). The server device 20 transmits the extracted user ID “#2” to the mobile terminal device 41 (Step S107).

Furthermore, the server device 20 stores the received password in the user ID table in a manner associated with the e-mail address B.

Incidentally, when the server device 20 has registered a user ID table in the user-ID-table storage unit 21, the server device 20 creates a message box with respect to each user ID included in the user ID table, and stores the created message box in the message-box storage unit 23. In this example, the user IDs “#1” and “#2” have been created in the user ID table; therefore, a message box 230 corresponding to the user ID “#1” and a message box 231 corresponding to the user ID “#2” are created.

When the mobile terminal device 40 has received the user ID “#1” transmitted from the server device 20 at Step S104, the mobile terminal device 40 starts polling the server device 20 and determines whether or not any message has been stored in the message box 230 corresponding to the user ID “#1” (Steps S109 and S110). Likewise, when the mobile terminal device 41 has received the user ID “#2” transmitted from the server device 20 at Step S107, the mobile terminal device 41 starts polling the server device 20 and determines whether or not any message has been stored in the message box 231 corresponding to the user ID “#2” (Steps S111 and S112).

When the mobile terminal device 40 has received the user ID “#1” transmitted from the server device 20 at Step S104, the main screen 100 displayed on the display unit 406 makes the transition to an imaging screen, and the mobile terminal device 40 goes into a state capable of taking an image to be shared with the user B (Step S108).

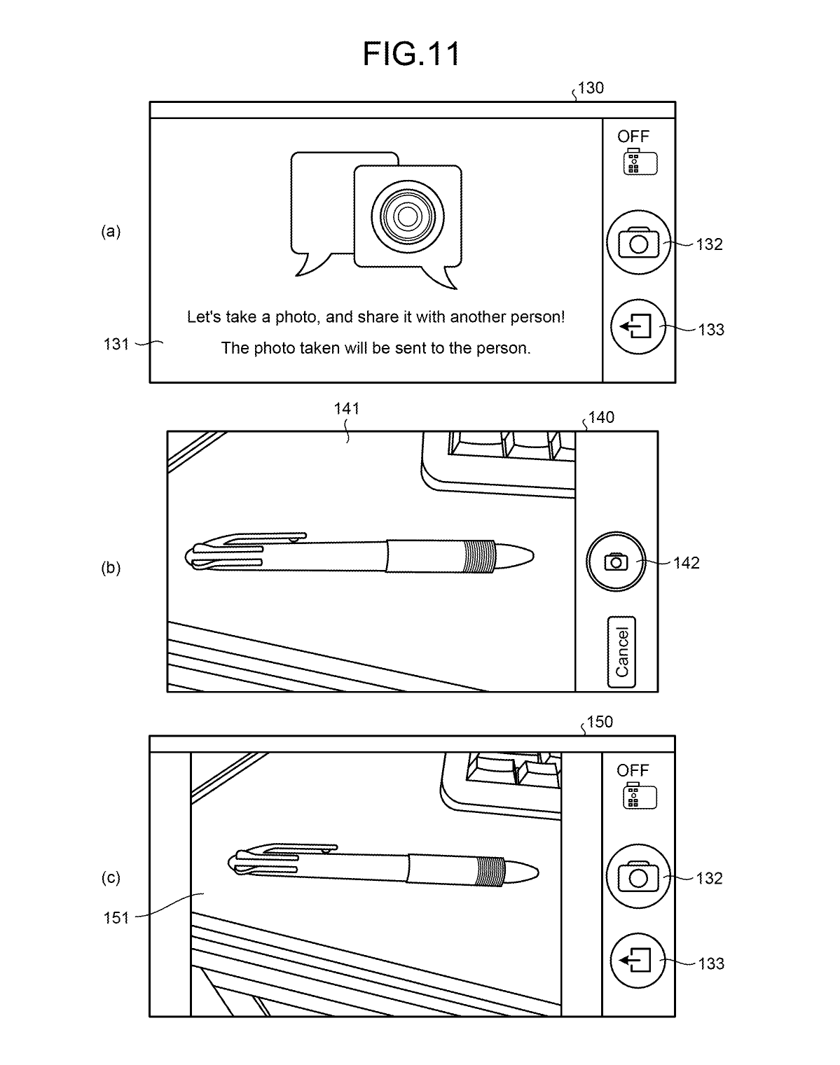

FIGS. 11(a) to 11(c) show examples of the imaging screen displayed on the display unit 406 of the mobile terminal device 40 according to the embodiment. FIG. 11(a) shows an example of an imaging preparation screen 130 for preparing for imaging. In this example, a message prompting an imaging operation is displayed on a display area 131 of the imaging preparation screen 130. Furthermore, in the example shown in FIG. 11(a), a preview button 132 and a transfer button 133 are provided on the right side of the imaging preparation screen 130.

When the preview button 132 on the imaging preparation screen 130 has been pressed, the display screen of the display unit 406 is changed to an imaging screen 140 illustrated in FIG. 11(b). An image of image data output from the imaging unit 411 is displayed on an imaged image area 141 of the imaging screen 140. By pressing a capture button 142, image data of the image displayed on the imaged image area 141 is captured and stored in the storage 407 (Step S113).

After the image data has been captured, the display screen of the display unit 406 is changed to a confirmation screen 150 illustrated in FIG. 11(c). An image of the image data stored in the storage 407 by the last pressing operation on the capture button 142 is displayed on an image area 151 of the confirmation screen 150. When the transfer button 133 has been pressed in a state where the image is displayed on the image area 151, the image data displayed on the image area 151 is transmitted and uploaded to the server device 20 (Step S114). At this time, in the mobile terminal device 40, the image transmitting unit 422 encrypts the image data to be transmitted by using the password that the user A has input to the input box 112 on the main screen 100 of the mobile terminal device 40. Then, the image transmitting unit 422 adds the user ID “#1” acquired from the server device 20 at Step S104 to the encrypted image data, and uploads the image data to the server device 20. The server device 20 stores the image data uploaded from the mobile terminal device 40 in the object storage 22 in a manner associated with the user ID “#1”.

Furthermore, the mobile terminal device 40 transmits the e-mail address B of the other party (the user B) with whom the user A shares the image data to the server device 20, and requests a user ID of the user B from the server device 20 (Step S115). The server device 20 searches for a user ID table including the received e-mail address B in the user-ID-table storage unit 21. Then, the server device 20 extracts user ID “#2” associated with the e-mail address B from the retrieved user ID table, and transmits the extracted user ID “#2” to the mobile terminal device 40 (Step S116).

When the mobile terminal device 40 has received the user ID “#2” of the other party with whom the user A shares the image data from the server device 20, the mobile terminal device 40 sends a message addressed to the user ID “#2” which includes the user ID “#1” to the server device 20 (Step S117). The message can further include information indicating that the user A uploaded the image data. When the server device 20 has received the message addressed to the user ID “#2” sent from the mobile terminal device 40, the server device 20 stores the received message in the message box 231 for the user ID “#2” specified as a destination.

As described at the above Steps S109 to S112, the mobile terminal devices 40 and 41 poll the server device 20, and determine whether or not any message addressed to a corresponding user ID has been stored in the message boxes 230 and 231. The mobile terminal device 41 polls the server device 20, and determines whether or not any message has been stored in the message box 231 corresponding to the user ID “#2”.

In this example, the message sent from the mobile terminal device 40 at Step S117 has been stored in the message box 231. Therefore, the mobile terminal device 41 determines that a message has been stored in the message box 231, and acquires the message from the message box 231 (Step S118).

The mobile terminal device 41 transmits the user ID “#1” included as a “source” in the message acquired at Step S118 to the server device 20, and requests image data from the server device 20 (Step S120). In accordance with the user ID “#1” transmitted from the mobile terminal device 41, the server device 20 searches for image data associated with the user ID “#1” in the object storage 22. At this time, when multiple image data associated with the user ID “#1” have been found in the object storage 22, the server device 20 retrieves the latest one in the multiple image data. The server device 20 transmits the image data retrieved from the object storage 22 to the mobile terminal device 41. Accordingly, the image data is downloaded into the mobile terminal device 41 (Step S121).

The mobile terminal device 41 decrypts the image data downloaded from the server device 20 at Step S121 by using the password input to the input box 112 on the main screen 100 of the mobile terminal device 41. Incidentally, the password shall be shared between the user A and the user B by using an arbitrary method, such as verbal communication or exchange of a handwritten note or an e-mail. The mobile terminal device 41 displays the decrypted image data on the display unit 406, and transmits the image data to the projector device 33 registered at Step S101. The projector device 33 projects an image of the image data transmitted from the mobile terminal device 41 on the screen 35 (Step S122).

In this manner, according to the present embodiment, each of the user A in the meeting room X and the user B in the meeting room Y remote from the meeting room X just transmits his/her e-mail address and an e-mail address of the other party to the server device 20, thereby image data owned by the user A can be shared between the meeting room X and the meeting room Y.

Incidentally, the mobile terminal device 40 can display the image data captured and stored in the storage 407 at Step S113 on the display unit 406, and can transmit the image data to the projector device 30 registered at Step S100 (Step S119). The projector device 30 projects an image of the image data transmitted from the mobile terminal device 40 on the screen 32. Accordingly, the users A and B can have a meeting in the different meeting rooms X and Y by using a shared image.

In the above, as the way of displaying device-specific information to specify, for example, the projector device 30, a two-dimensional matrix code is printed on a printed medium, and the printed medium is stuck to the housing of the projector device 30; however, the way of displaying device-specific information is not limited to this example. For example, the projector device 30 can project an image of the two-dimensional matrix code, which has been held in a storage medium (not shown) such as a ROM or HDD included in the projector device 30 in advance, on the screen 32. Furthermore, the projector device 30 can be configured to project an image of an IP address or MAC address assigned to the projector device 30 on the screen 32. By pressing the scan start button 113 of the mobile terminal device 40, an image of the device-specific information, for example, the two-dimensional matrix code, the IP address, or the MAC address projected on the screen 32 is acquired.

In the case of using the two-dimensional matrix code printed on the printed medium, the place to which the printed medium is stuck is not limited to the housing of the projector device 30. For example, the printed medium can be stuck to an accessory of the projector device 30, such as a remote controller of the projector device 30 or a storage case of the projector device 30.

Furthermore, in the above, respective pieces of device-specific information that specify the projector devices 30 and 33 are acquired from images; however, the way of acquiring the device-specific information is not limited to this example. For example, the device-specific information can be acquired in such a manner that the device-specific information is stored in an integrated circuit (IC) chip capable of near field communication, and the IC chip is stuck to, for example, the housing of the projector device 30, and then the mobile terminal device 40 compatible with near field communication reads the device-specific information from the IC chip.

Furthermore, the device-specific information can be acquired from the projector device 30 by using a communication interface such as a Bluetooth (registered trademark) interface. Moreover, the device-specific information can be acquired from sound information in such a manner that the projector device 30 modulates the device-specific information into a predetermined frequency band of sound wave such as a ultrasonic wave, and outputs the predetermined frequency band of sound wave, and the mobile terminal device 40 detects and demodulates the predetermined frequency band of sound wave into the device-specific information.

That is, the way of sticking respective two-dimensional matrix codes to the bodies of the projector devices 30 and 33 is just adopted as a preferred means based on the following points: if there is any change in the device-specific information, the user only has to re-stick a changed two-dimensional matrix code; the user can visually, directly confirm the presence or absence of the device-specific information on the projector device 30; and cell-phone terminals, PHS terminals, smartphones, and tablet computers, etc. which can be applied as the mobile terminal devices 40 and 41 have a function of reading a two-dimensional matrix code as a standard feature.

Incidentally, in the embodiment described above, the server device 20 creates a user ID corresponding to a received e-mail address, and transmits the created user ID to the mobile terminal devices 40 and 41; however, user identifying information is not limited to this example. For example, the server device 20 can use the e-mail address as user identifying information without creating a user ID. In the above, the created user ID is used, taking into consideration that if an e-mail address is used as a user ID, user identifying information may be lengthy, and an e-mail address is not highly-confidential information. Besides this, even by using other user identifiable information, data sharing can be performed as in the above-described embodiment.

Furthermore, in the above, an e-mail address, which is user-indicating information, is used as information to identify a sharing target with which the mobile terminal devices 40 and 41 share data, and, in a data sharing process, a sharing target is identified on the basis of a created user ID; however, the way of identifying a sharing target is not limited to this example. That is, information to identify a sharing target can be any information unique to the sharing target, and includes, for example, phone numbers of the mobile terminal devices 40 and 41. In short, in the embodiment, an e-mail address or a created user ID is used as information to specify the other party (a device at the other end or a user of the device) with which a mobile terminal device shares data; therefore, the users A and B have only to specify a sharing target (the other party) from their mobile terminal devices 40 and 41, respectively. Furthermore, user-indicating information has not necessarily been registered in the mobile terminal devices 40 and 41; for example, user-indicating information can be stored in en external device, and the users A and B can access the external device to acquire the user-indicating information or a list of the user-indicating information from the external device and select a sharing target (the other party).

Moreover, when a data sharing process is performed by using unique information, such as an e-mail address or a phone number, owned by the mobile terminal devices 40 and 41 subjected to the data sharing process as information to identify a sharing target, instead of transmitting information to identify a sharing target to the mobile terminal devices 40 and 41, the server device 20 can transmit a notification indicating completion of registration in a user ID table of the server device 20. When the mobile terminal devices 40 and 41 have received the notification indicating completion of registration, the mobile terminal devices 40 and 41 perform data sharing by performing processes, such as the upload and download of data and the transmission of a message, using the information such as an e-mail address or a phone number.

Incidentally, in the embodiment described above, each password input through the main screen 100 is held by the mobile terminal devices 40 and 41, and is used in encryption and decryption of image data. The retention of the password is not limited to this example, and the password can be held, for example, in the user ID table of the server device 20. In the embodiment described above, the mobile terminal devices 40 and 41 use a common password in encryption and decryption; therefore, it is necessary to share the password between users of the mobile terminal devices 40 and 41 in advance. On the other hand, when the password is held in the user ID table of the server device 20, it can be configured that a password registered by one user can be acquired by the other user.

Specifically, at Step S102 in FIG. 8, the mobile terminal device 40 of the user A transmits the e-mail addresses of the users A and B input to the input boxes 110 and 111 and the password input to the input box 112 on the main screen 100 of the mobile terminal device 40 to the server device 20. At Step S103, the server device 20 holds respective user IDs created for the e-mail addresses of the users A and B in the user ID table in a manner associated with the password. After that, at Step S105, the mobile terminal device 41 of the user B transmits the e-mail addresses of the users B and A input to the input boxes 110 and 111 on the main screen 100 of the mobile terminal device 41 to the server device 20. For example, at Step S106, the server device 20 determines whether the e-mail addresses or user Its of the users A and B have already been registered in the user ID table in a manner associated with the password. When having determined that the e-mail addresses or user IDs of the users A and B have already been registered, the server device 20 transmits the password associated with the e-mail address or user ID of the user B to the mobile terminal device 41 of the user B. By doing this, either one of the users A and B who share data with each other only has to perform a password input operation. Furthermore, when the password is held by the server device 20, the encryption or decryption process can be performed by the server device 20.

Incidentally, in the embodiment described above, user-indicating information to be input to the input box 111 not limited to one piece of user-indicating information that indicates one user, and multiple pieces of user-indicating information that indicate multiple users can be input to the input box 111. For example, some users can be selected from multiple pieces of user-indicating information for multiple users registered in the mobile terminal device 40 in advance, and respective pieces of user-indicating information that indicate the selected users can be registered. When multiple users are specified, a message is sent to message boxes for the multiple users.

Furthermore, in the embodiment described above, a device held and operated by a user is explained as the mobile terminal device that a user can easily carry around. By using a device that a user can carry around like this, the user can implement the embodiment in any places where the user is. However, the embodiment can be applied not only to such a portable device but also to an information processing apparatus that a user does not normally carry around to use, such as a stationary personal computer.

Moreover, in the above, various types of information processing apparatuses, such as a cell-phone terminal, a PHS terminal, a smartphone, and a tablet computer, are mentioned as examples of the mobile terminal devices 40 and 41 according to the embodiment; however, the mobile terminal devices 40 and 41 are not limited to these examples. For example, an image pickup device, such as a digital camera, can be used as the mobile terminal devices 40 and 41. Furthermore, the projector devices 30 and 33 can be used as the mobile terminal devices 40 and 41.

Furthermore, data to be shared is not limited to image data of an image taken by the imaging unit 411. For example, image data created by the user A with an electronic pen or the touch of an entry area displayed on the display screen of the mobile terminal device 40 can be transmitted to the mobile terminal device 41 to cause the projector device 33 to project the image data, or image data acquired from another device with which the mobile terminal device 40 establishes communication, such as near field communication using Bluetooth (registered trademark), can be shared with the mobile terminal device 41 and the projector device 33.

Moreover, devices registered by the mobile terminal devices 40 and 41 at Steps S100 and S101 in FIG. 8 are not limited to the projector devices 30 and 33. For example, devices registered by the mobile terminal devices 40 and 41 can be electronic blackboard devices capable of saving and transmitting content written on a blackboard as an image and also capable of displaying thereon an image of received image data, other mobile terminal devices, and other devices having a function of displaying data.

Furthermore, the number of devices registered by the mobile terminal device 40 or 41 at Step S100 or S101 is not limited to one. Respective pieces of device-specific information can be acquired from multiple devices out of projector devices and other devices having the display function, and the acquired pieces of device-specific information can be registered.

Moreover, the mobile terminal device 41 can be configured to start polling the server device 20 on the basis of another operation instructing to start polling instead of the input operation at Step S105 in FIG. 8. That is, for example, assume that it is clear that in the meeting, the mobile terminal device 40 of the user A is a source of image data to be shared (a device that wants to share image data with the mobile terminal device 41), and the mobile terminal device 41 of the user B is a destination of the image data to be shared (a device with which the mobile terminal device 40 wants to share the image data). In this case, the mobile terminal device 41 of the user B does not have to transmit image data to the server device 20, and does not have to send a message based on a user ID of the user A. Therefore, even without specifying the e-mail address of the user A as in Step S105 in FIG. 8, the mobile terminal device 41 just has to transmit the e-mail address of the user B (the mobile terminal device 41) to the server device 20 on the basis of an operation instructing to start polling thereby acquiring a user ID and start polling a message box on the basis of the acquired user ID.

Furthermore, after completion of the processes performed by the mobile terminal device 40 of the user A at Step S102 to S104 in FIG. 8, the mobile terminal device 41 of the user B can transmit the e-mail address of the user B (the mobile terminal device 41) to the server device 20, thereby acquiring a user ID of the user A from the user ID table. That is, the mobile terminal device 41 requests the server device 20 to check if there is any user who wants to share image data with the user B (the mobile terminal device 41) on the basis of the user ID table, and, if there is a user, to transmit a user ID of the user. Accordingly, the input operation to the main screen 100 of the mobile terminal device 41 made by the user B can be reduced.

In summary, as an example of the present invention, a system according to the present invention includes a first information processing apparatus (for example, the mobile terminal device 40), one or more first display devices (for example, the projector device 30), a second information processing apparatus (for example, the mobile terminal device 41), one or more second display devices (for example, the projector device 33), and a server device, and is a system that performs data sharing between a usage environment of the first information processing apparatus and a usage environment of the second information processing apparatus.

The first information processing apparatus can acquire device-specific information to identify the one or more first display devices and transmit data to the identified first display device(s) to display the data on the first display device(s). Just like the first information processing apparatus, the second information processing apparatus also can transmit data to the identified second display device(s) to display the data on the second display device(s). Incidentally, in the system according to the present invention, the first display device(s) is not an essential component.

The first information processing apparatus transmits identification information (for example, an e-mail address) that specifies a sharing target of data sharing to the server device. The server device registers the received identification information or identification information (for example, a user ID) created on the basis of the received identification information, and manages the sharing target.

On that basis, the first information processing apparatus transmits shared data to be shared with the sharing target to the server device, and the server device registers (stores) the shared data in a storage unit. Then, the server device transmits the shared data to the second information processing apparatus in accordance with the identification information of the sharing target managed, and, when the second information processing apparatus has received the shared data, the second information processing apparatus transmits the shared data to the identified second display device(s) to display the shared data on the second display device(s).

The server device further includes, as a concrete means of managing and providing shared data, a data storage unit (for example, the object storage 22) and a message storage unit (for example, the message-box storage unit 23); the data storage unit stores therein shared data in a manner associated with identification information, and the message storage unit stores therein a message (a message including identification information to identify (specify) shared data) in a manner associated with the identification information. The server device records the shared data and identification information received from the first or second information processing apparatus in the data storage unit, and further records a message associated with identification information corresponding to a destination device out of sharing targets of data sharing in the message storage unit. Then, the server device transmits the message to the second or first information processing apparatus on the basis of the identification information, and transmits the shared data to the second or first information processing apparatus on the basis of the identification information to specify the shared data included in the message.

As can be seen from the above-described summary, a user ID used in the above-described embodiment is used as identification information to identify either one of the first information processing apparatus or its user and the second information processing apparatus or its user as a target of sharing of data owned by the other. Furthermore, a user ID is also used as identification information to identify (specify) shared data that the server device has received. Moreover, a user ID is also used as identification information to acquire the identification information to identify (specify) shared data.

In this manner, in the embodiment, a user ID is used as several kinds of identification information for different usage applications in common. However, the present invention is not limited to this example; without using common identification information, different identification information can be used with respect to each usage application. For example, a URL can be used as information to identify data recorded in the data storage unit, and a message including the URL can be sent, or an e-mail address can be used in sending of a message.

Incidentally, as described above, the server device (the server device 20) according to the embodiment can be composed of one or more information processing apparatuses; also, the server device can be considered as an information processing system composed of one or more information processing apparatuses. Therefore, the information processing system according to the embodiment includes functional parts causing the server device 20 to execute processes (functions) in the above-described embodiment.

Furthermore, some of the functional parts included in the information processing system according to the embodiment can be realized by an external device or an external system composed of one or more information processing apparatuses. For example, the message storing function of the message-box storage unit 23 can be realized by using a mail server. Furthermore, for example, the data storing function of the user-ID-table storage unit 21 can be realized by using an online storage service.

Incidentally, the above-described embodiment is a preferred practical example of the present invention; however, the present invention is not limited to this embodiment, and various modifications can be made without departing from the scope of the present invention.

According to the present invention, it is possible to facilitate sharing of an image among remote locations.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implemental on a programmable device. The computer software can be provided to the programmable device using any storage medium for storing processor readable code such as a floppy disk, hard disk, CD ROM, magnetic tape device or solid state memory device. The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data sharing system in which an information processing system composed of one or more computer devices and multiple information processing apparatuses are connected via a network so that the information processing system and the information processing apparatuses can communicate with one another, wherein
each information processing apparatus includes:
a device-specific-information acquiring unit configured to acquire device-specific information;
a connecting unit configured to connect the information processing apparatus to a display device specified on the basis of the acquired device-specific information;
a sharing-target transmitting unit configured to transmit designation information designating a sharing target of data sharing to the information processing system;
a first data transmitting unit configured to transmit, to the information processing system, shared data to be shared with the sharing target designated by the designation information;
a data receiving unit configured to receive, out of the shared data that the information processing system has received and recorded in a storage unit, shared data to be shared with the information processing apparatus designated as a sharing target from the information processing system; and
a second data transmitting unit configured to transmit the shared data received by the data receiving unit to the display device connected by the connecting unit, and
the information processing system includes:
a sharing-target receiving unit configured to receive the designation information from the information processing apparatus; and
a data recording unit configured to record, in the storage unit, the shared data received from information processing apparatus in a manner associated with the sharing target indicated by the designation information received by the sharing-target receiving unit.

2. The data sharing system according to claim 1, wherein
a first information processing apparatus out of the multiple information processing apparatuses transmits designation information to the information processing system through the sharing-target transmitting unit,
a second information processing apparatus out of the multiple information processing apparatuses receives shared data to be shared with the second information processing apparatus designated as a sharing target from the information processing system through the data receiving unit, and the second information processing apparatus transmits, by the second data transmitting unit, the received shared data to the display device connected by the connecting unit on the basis of device-specific information acquired by the device-specific-information acquiring unit.

3. The data sharing system according to claim 1, wherein
the information processing system further includes:
a sharing-target registering unit configured to register sharing-target identifying information to identify a sharing target on the basis of received designation information; and
a managing unit configured to manage the received shared data and the sharing-target identifying information in an associated manner, and
the data receiving unit receives, from the information processing system, shared data to be shared with the information processing apparatus designated as a sharing target specified on the basis of information that identifies the information processing apparatus and sharing-target identifying information.

4. The data sharing system according to claim 1, wherein
the device-specific-information acquiring unit acquires the device-specific information by using a generic function that the first and second information processing apparatuses both have.

5. The data sharing system according to claim 1, wherein
the sharing-target transmitting unit transmits, to the information processing system, information designating a sharing target of data sharing set by using a generic function that the first and second information processing apparatuses both have.

6. The data sharing system according to claim 1, wherein
the information processing system further includes a data-specific-information recording unit configured to record, in a storage unit, shared-data-specific information that specifies data to be shared in a manner associated with sharing-target identifying information,
the data recording unit records, in the storage unit, shared data received from the first information processing apparatus, in a manner associated with information that identifies the first information processing apparatus designated as a sharing target,
the data-specific-information recording unit records information that specifies the shared data, which has been recorded in the storage unit in a manner associated with the information that identifies the first information processing apparatus, in a manner associated with information that identifies the second information processing apparatus designated as a sharing target,
the managing unit associates the shared data with the sharing-target identifying information by using the data recording unit and the data-specific-information recording unit, and
the data receiving unit receives the shared data from the information processing system by the information that specifies the shared data specified on the basis of the information that identifies the second information processing apparatus and the sharing-target identifying information.

7. The data sharing system according to claim 6, wherein
the sharing-target identifying information and the shared-data-specific information use common identification information as identification information to identify the first information processing apparatus or a user of the first information processing apparatus and the second information processing apparatus or a user of the second information processing apparatus.

8. The data sharing system according to claim 6, wherein
the sharing-target identifying information and the shared-data-specific information use different identification information as identification information to identify the first information processing apparatus or a user of the first information processing apparatus and the second information processing apparatus or a user of the second information processing apparatus.

9. An information processing apparatus in a data sharing system in which an information processing system composed of one or more computer devices and multiple information processing apparatuses are connected via a network so that the information processing system and the information processing apparatuses can communicate with one another, the information processing apparatus comprising:
a device-specific-information acquiring unit configured to acquire device-specific information;
a connecting unit configured to connect the information processing apparatus to a display device specified on the basis of the acquired device-specific information;
a sharing-target transmitting unit configured to transmit, to the information processing system, designation information to designate a sharing target of data sharing;
a first data transmitting unit configured to transmit, to the information processing system, shared data to be shared with the sharing target designated by the designation information;
a data receiving unit configured to receive, out of shared data that the information processing system has received and recorded in a storage unit, shared data to be shared with the information processing apparatus designated as a sharing target from the information processing system; and
a second data transmitting unit configured to transmit the shared data received by the data receiving unit to the display device connected by the connecting unit.

10. The information processing apparatus according to claim 9, wherein
after a first information processing apparatus out of the multiple information processing apparatuses has designated a sharing target through the sharing-target transmitting unit and transmitted shared data to be shared with the designated sharing target through the first data transmitting unit, a second information processing apparatus out of the multiple information processing apparatuses receives, through the data receiving unit, the shared data to be shared with the second information processing apparatus designated as a sharing target from the information processing system.

11. A data sharing method for sharing data between first and second information processing apparatuses which are connected to an information processing system composed of one or more computer devices via a network so that the information processing system and the first and second information processing apparatuses can communicate with one another, the data sharing method comprising:
a device-specific-information acquiring step of the first information processing apparatus acquiring device-specific information;
a connecting step of the first information processing apparatus connecting to a display device specified on the basis of the acquired device-specific information;
a displaying step of the second information processing apparatus displaying a screen through which a sharing target of data sharing is designated;
a sharing-target transmitting step of the second information processing apparatus transmitting, to the information processing system, designation information to designate the sharing target;
a first data transmitting step of the second information processing apparatus transmitting, to the information processing system, shared data to be shared with the designated sharing target;
a data receiving step of the first information processing apparatus transmitting sharing-target identifying information that identifies the sharing target to the information processing system and receiving, out of the shared data transmitted at the first data transmitting step, shared data to be shared with the first information processing apparatus designated as a sharing target from the information processing system on the basis of the sharing-target identifying information; and
a second data transmitting step of the first information processing apparatus transmitting the data received at the data receiving step to the display device connected at the connecting step.
